(19) United States
(12) Patent Application Publication
(10) Pub. No.: US 2019/0194082 A1
(43) Pub. Date: Jun. 27, 2019

(54) ORGANIC WASTE TREATMENT SYSTEM AND METHOD

(71) Applicant: Nezar Bakhsh, Jeddah (SA)

(72) Inventor: Nezar Bakhsh, Jeddah (SA)

(21) Appl. No.: 16/292,400

(22) Filed: Mar. 5, 2019

(51) Int. Cl. C05F 17/02; C05F 17/00; A23K 10/10

(52) U.S. Cl. CPC C05F 17/0247; A23K 10/10; C05F 17/0009

(57) ABSTRACT

The present invention relates to a bio-conversion treatment method and related system that uses one or more species of microorganisms preferably larvae of Black Soldier Fly Larvae (BSFL) to effectively convert organic waste into harmless and value-added products such as fertilizers and animal feed.

### TECHNICAL FIELD

The present invention relates generally to waste treatment, and particularly to a method and system for organic waste treatment.

### BACKGROUND

Large amounts of organic waste are generated annually from agricultural plantations, animal farms, mills, food processing plants and industrial plants. The amount of organic waste generated has been increasing each year as the agro-food industries expand. Consequently, the disposal and proper utilization of these wastes has been a major concern in recent years.

Further, organic waste generated such as industrial waste, animal and plant by-products, and faeces are a major cause of environmental pollution. Conventionally, different methods are available for safe disposal of these organic waste and for conversion of the waste into animal feed. Examples of popular conventional methods are landfilling and incineration. Landfills require extensive areas and are both unsanitary as well as require higher management cost. Further, landfills create problems such as the leaching of harmful chemicals into the soil, contaminating ground water, and causing loss of essential nutrients which are present into the soil. Incineration is also expensive, and creates environmental problems.

Further, feeding the treated waste generated out of the landfilling and incineration to animals without further processing may cause various health problems for the animals. Also, the resultant product from these treatment methods doesn't serve to provide satisfactory fertilizer effect.

In the past, the best solutions proposed to overcome such problems is to utilize microorganisms such as different species of larvae of earthworms and/or house flies, to efficiently treat the organic waste to produce quality fertilizers and animal feed. The fertilizers produced using such bio-conversion/biological treatment methods are usually found to have better fertilizer effects, which in turn improves overall plant growth and crop yields. Although, several biological treatment methods were proposed in the past for treating the organic waste to address the problem of organic waste disposal and conversion of organic waste into harmless and more value-added products. Most of such existing solutions require lot of time and human efforts as most of the existing systems are manual systems, and require huge management cost incurred after maintenance of such systems and human force working on such systems.

Further, as the existing biological treatment methods and systems are handled manually and are labour intensive, thus they suffer scalability issues, especially when there is a huge demand for the fertilizers and animal feed. Existing solutions or designs are box shaped and are handled by using conveyor belts and long shelves. Those shelves are then connected to motors and conveyors that consume lot of electricity to operate through conversion cycles. When the demand is huge, then it is certain that such existing solutions would not be cost effective. Further, to meet the huge demand or mass production of the fertilizers and animal feed out of the organic waste such solutions will require significant design changes which is practically impossible to implement.

A number of prior art discloses various methods and systems for safe disposal of organic waste or conversion of organic waste into fertilizers or animal feed or the like. For example, U.S. Pat. No. 6,780,637 describes a method and system for efficiently bio-converting putrescent wastes to a more usable form. U.S. Pat. No. '673 discloses a bio-conversion unit for facilitating bio-conversion of waste material. The bio-conversion unit includes a rounded container with two small ramps (spiraling up from bottom to top) configured inside of the container.

U.S. Pat. No. 5,082,486 teaches a method for the production of organic compost. As disclosed, the method discloses shredding the refuse, adding water to saturation, adding earthworms, keeping the water content at more than 80% during at least 30 days, keeping the mixture at a temperature from 0-54° C. and with a moisture of at least 45% during more than 4 months.

U.S. Pat. No. 6,001,146 describes about a device and a method for the continuous treatment of putrescent waste in which the waste is eaten by fly larvae. As disclosed in the patent, the device comprises a conveyor belt, a means to distribute the waste, a means for depositing fly larvae or fly larvae eggs onto the waste, a means for removing fly larvae from the waste and from the conveyor belt, and a means for removing the waste from the conveyor belt.

WO2008134865 describes a system for processing organic waste using insect larvae. According to the application, the system includes multiple substantially flat reaction vessels stacked one on top of the other, to form a processing block. Each of the reaction vessels in the processing block is configured to hold quantity of organic waste. Each of the reaction vessels is separated from the reaction vessel above by an air space and the processing block is contained in a plant enclosure having side walls. At least one of the side walls of the plant enclosure is positioned adjacent the processing block such that the plenum wall is adjacent one of the side edges of the reaction vessels. The plenum wall has openings which communicate with the air spaces. The openings are positioned on the plenum wall such that the openings are immediately adjacent the air spaces. The system further includes an air circulation system for circulating air through the air spaces by passing air through the openings in the plenum wall and a feeder system for loading raw organic waste onto the reaction vessels. The reaction vessels preferably being an elongated belt, which consists of an elongated flexible web suspended between a pair of rollers.

In the light of foregoing, and although the prior arts exists in the space, inventor still feels there is sufficient space for an improved system and method for treatment of organic waste that overcomes, or at least ameliorates the disadvantages described above.

### SUMMARY

It is an objective of the present invention to provide a bio-conversion method for the treatment of organic waste.

It is another objective of the invention to provide an organic waste treatment system and method that utilizes a certain species of microorganisms Eg. larvae of Black Soldier Fly Larvae (BSFL) to effectively convert organic waste into harmless and more value-added products such as fertilizers and animal feed.

It is a further objective of the invention to provide a method and system for treatment of the organic waste that can effectively produce a commercially valuable product in a large scale in a reduced amount of time with lesser human efforts.

Another objective of the invention is to provide a method for treatment of organic waste that uses no chemicals rather uses larvae of Black Soldier Fly Larvae (BSFL).

It is an object of the invention to provide an improved bio conversion system, which is inexpensive, modular, dependable and fully effective for treatment of organic waste.

It is an object of the invention to provide a system for organic waste treatment which is cylindrical in shape that eases collection and cleaning of the system after the cycle is complete and then run next cycle.

According to an aspect of the present invention, a system for treatment of organic waste is disclosed. The system includes a tower including a first section, and a second section operationally engaged to the first section, each of the first section and the second section comprises a plurality of first floors, a plurality of second floors respectively, wherein each of the first floors of the first section is configured to receive and facilitate conversion of the organic waste into one or more value-added products, and serve as a pathway for each of the floors of the second section, when the second section is operated to rotate within the first section.

According to the same aspect, the organic waste are pre-processed before channelling into the selected floors of the plurality of first floors of the first section. The pre-processing includes: shredding the organic waste into tiny chunks, sorting and transferring the shredded waste to one or more storage tanks based on food types, adding a chemical agent to the organic waste stored in the storage tanks to maintain safety and freshness of the stored organic waste, transferring different types of stored organic waste in different ratios from different tanks into a mixer for blending, adding water and identifying the correct moisture amount for the organic waste during the mixing/blending process, and storing, the blended organic waste resulted out of the mixing process/blending process.

According to the same aspect, the system includes a support structure configured to support the tower.

According to the same aspect, the system includes at least one first passageway with a plurality of first nozzles, wherein the first passageway is mountable on the support structure for selectively channelling at least one of: the organic waste, and the one or more species of microorganisms into selected floors of the plurality of first floors of the first section.

According to the same aspect, the system further includes at least one second passageway with a plurality of second nozzles, wherein the second passageway is mountable on the support structure for channelling air into the plurality of first floors of the first section.

According to the same aspect, the system further includes at least one third passageway with a plurality of third nozzles, wherein the third passageway is mountable on the support structure for channelling air out of the plurality of first floors of the first section.

According to the same aspect, the system further includes a first motor adapted for operatively rotating the second section within the first section.

According to another aspect of the present invention, a method for treatment of organic waste using an organic waste treatment system is provided. The method includes the steps of: pre-processing the organic waste to form a blended organic waste, selectively channelling the pre-processed organic waste into a plurality of first floors of a first section of a tower using at least one first passageway having a plurality of first nozzles, selectively channelling one or more species of microorganisms into the first floors of the first section of the tower using the first passageway, channelling air into and out of the first floors of the first section using at least one second passageway and at least one third passageway, both having a plurality of first nozzles, and a plurality of first nozzles respectively, allowing the channelled microorganisms, and the pre-processed organic waste to remain in the first section of the tower for a specific period of time to convert the pre-processed organic waste to one or more value added products, and harvesting the value added products and the microorganism out of the first section, wherein the step of harvesting is facilitated by rotation of a plurality of second floors of a second section of the tower within the first section.

These and other objects of the present invention will become readily apparent upon further review of the following specification and drawings.

### BRIEF DESCRIPTION OF DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 shows a system for treatment of organic waste, according to an embodiment of the present invention.

FIG. 2 shows an exploded view of the system of FIG. 1, according to an embodiment of the present invention.

FIG. 3A shows a first section of a tower, according to an embodiment of the present invention.

FIG. 3B shows a second section of the tower, according to an embodiment of the present invention.

FIG. 4 shows larvae of Black Soldier Fly Larvae (BSFL) and organic waste undergoing bio conversion in the first section of the tower, according to an embodiment of the present invention.

FIGS. 5A-5D shows partial top views of the system of FIG. 1 showing rotational movement of the second section of the tower within the first section at time intervals T1-T4, according to an embodiment of the present invention.

### DETAILED DESCRIPTION

Various embodiments will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “an example”, “another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. Unless stated otherwise, terms such as “first”, “second”, “third”, “fourth”, are used to arbitrarily distinguish between the elements such terms describe. Thus, these terms are not necessarily intended to indicate temporal or other prioritization of such elements.

Unlike conventional systems and methods discussed above, the present invention discloses a bio-conversion method that uses a certain species of microorganisms, particularly larvae of Black Soldier Fly Larvae (BSFL) (Hermetia illucens) to effectively convert organic waste into harmless and more value-added products such as fertilizers and animal feed. The organic waste may include but not limited to industrial waste, animal and plant by-products, and faeces. The black soldier fly's developmental takes a specific period of time, within which its transitions take from an egg to a fully functioning adult. The specific period of time for the black soldier fly to get fully developed can take between 37-41 days, and out of these 41 possible days, approximately 14 days are spent decomposing organic wastes (during these 14 days, larvae of Black Soldier Fly are active on decomposing organic waste). Once these first 14 days have passed, the BSFL ceases to process the organic waste and instead migrates to a dry place so that it can begin to pupate. In an experiment conducted, where 5000 BSFLs were placed into a container with 10 kg of organic wastes contained therein. The BSFLs managed to decompose more than 80% of the organic waste within a period of 5 days, which resulted in a reduced volume of the organic waste by 42% and weight by 70%. In comparison to the efficiency of house fly larvae and earthworm larvae widely used in the conventional treatment methods, the BSFLs are found to be more efficient in achieving the desired high value products such as fertilizers and animal feed. In contrast to the earthworm larvae and house fly larvae used in conventional systems, the BSFLs spend much longer time decomposing the organic waste.

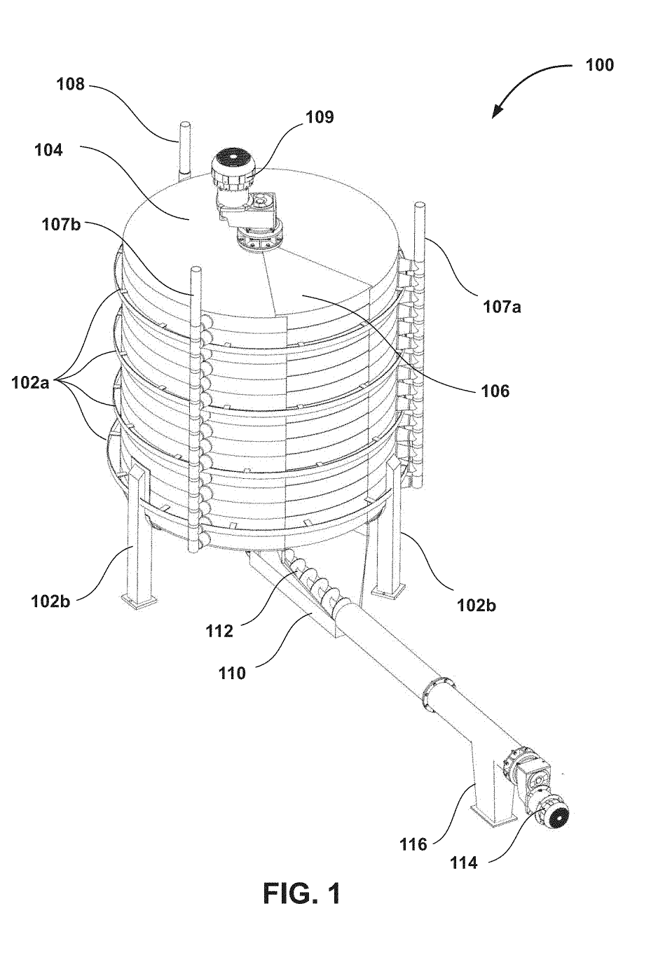

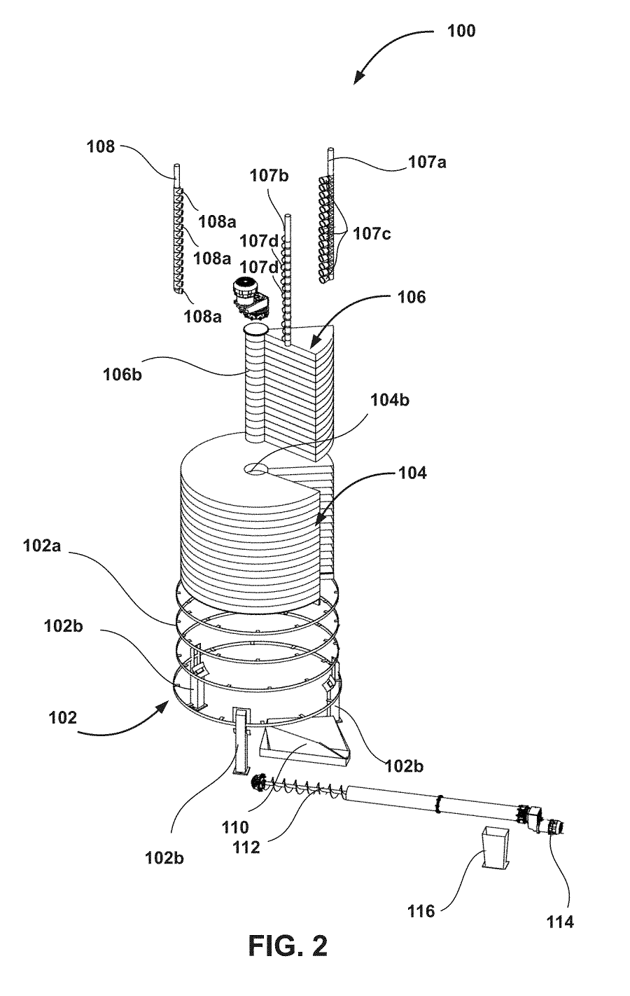

The various features and embodiments of the organic waste treatment system and method are better explained in conjunction with FIGS. 1-5.

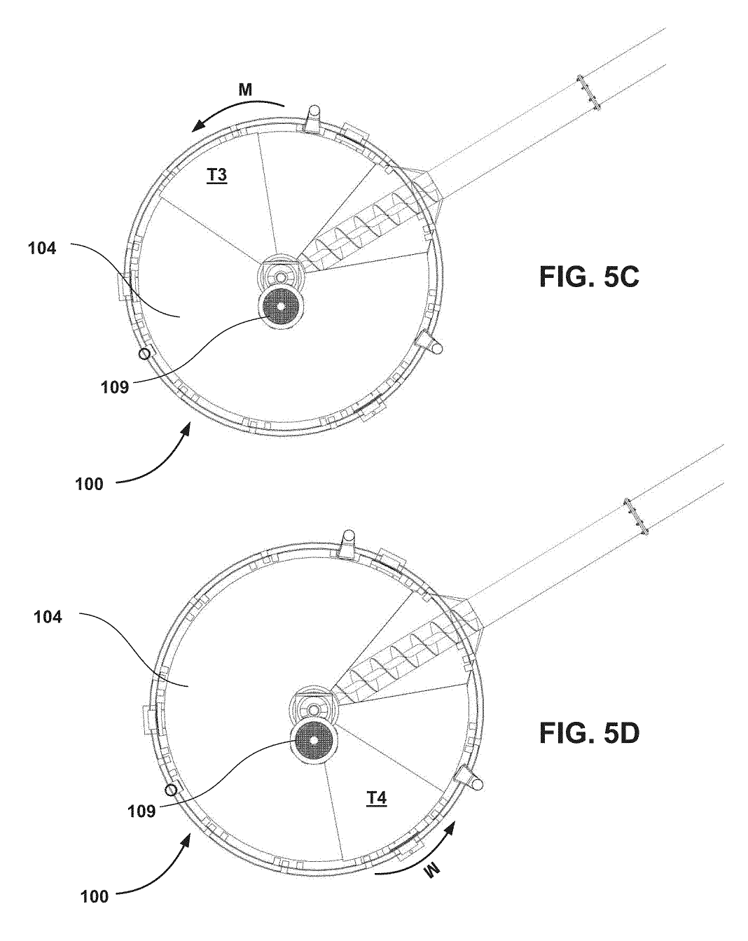

Referring to accompanying figures, the system 100 includes a tower preferably cylindrical or circular in shape. The tower includes a first section 104, and a second section 106 operationally engaged to the first section 104. The second section 106 of the tower is operationally engaged to the first section 104 using a shaft 106b configured thereon. The shaft 106b includes an end that connects to a motor 109 in order for the motor 109 to rotate the second section 106 within the first section 104. The rotation of second section 106 within the first section 104 at time intervals T1-T4 is depicted in the FIGS. 5A-5D.

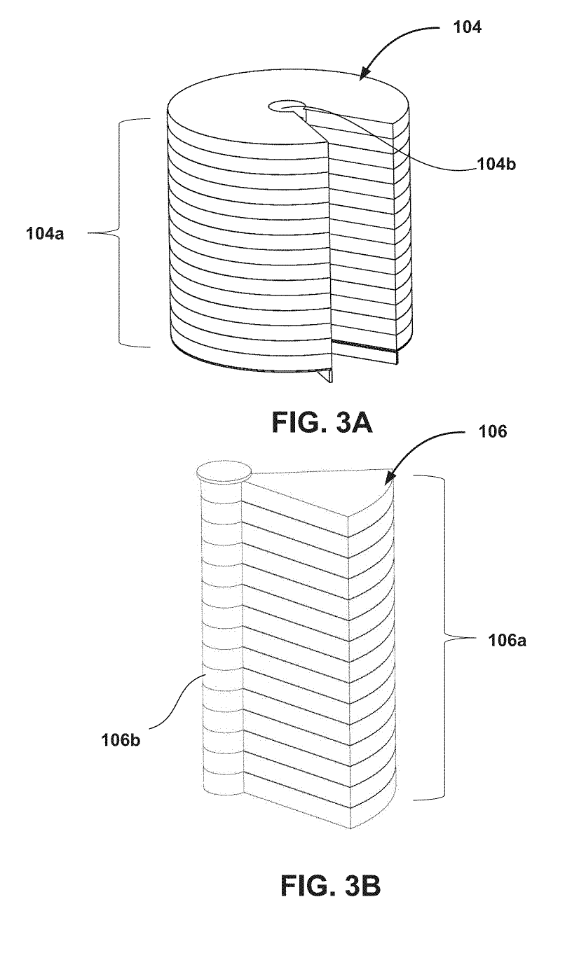

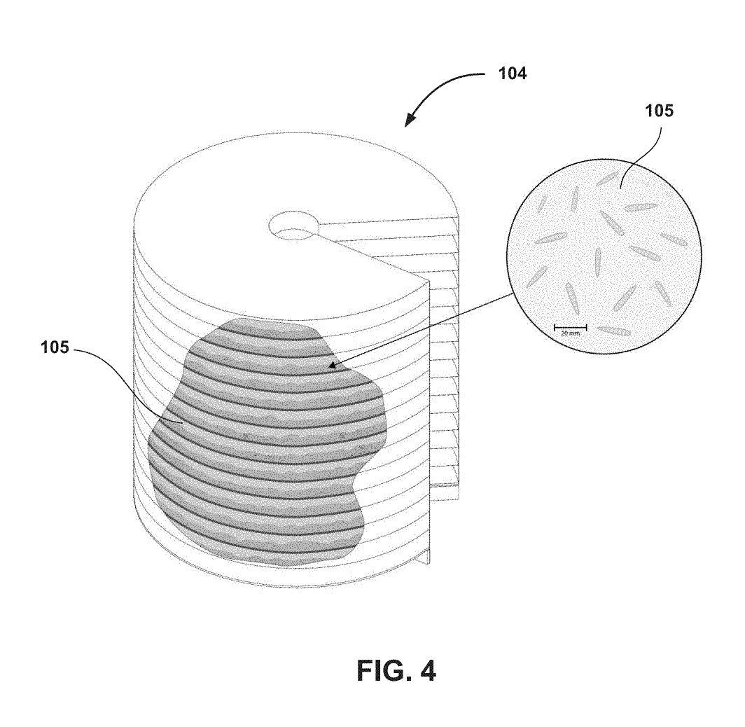

The first section 104 and the second section 106 both includes a plurality of floors collectively referred as 104a, and 106a respectively as shown in the FIGS. 3A-3B. According to an embodiment, the number of floors 104a of the first section 104 is equal to the number of floors 106a of the second section 106. According to another embodiment, the number of floors 104a of the first section 104 may not be equal to the number of floors 106a of the second section 106. The floors of the first section 104 of the tower includes a receiving slot 104b for receiving the shaft 106b of the second section 106 therein to facilitate rotation of the second section 106 within the first section 104. The rotation of the second section 106 within the first section 104 may be clockwise or anticlockwise.

Each of the floors 104a of the first section 104 is hollow and configured to receive and facilitate bio-conversion of the organic waste into one or more value-added products such as fertilizers and animal feed using one or more microorganisms preferably larvae of Black Soldier Fly Larvae (BSFL). Further, each of the floors 104a of the first section 104 is configured to serve a pathway for corresponding floors 106a (which are non-hollow) of the second section 106 when the second section 106 is operated to rotate within the first section 104 by using the motor 109. The floors 104a of the first section 104 are open at two ends in order to facilitate the second section 104 (having floors with non-open ends) to rotate within the first section 104 in order to eject or harvest the value added products out of the first section 104 after the treatment/bio-conversion process ends.

According to the embodiment, the system 100 further includes a support structure configured to support the tower. The support structure includes one or more rings 102a complementing to the shape of the tower. According to an embodiment, each of the rings 102a are interconnected to form a disposal space for receiving the tower. According to some other embodiment, the disposal space for receiving the tower may be formed using a one piece ring in the form of a continuous spiral. According to some other embodiment, the disposal space for receiving the tower may be formed by utilizing a cylindrical container or just a base that can hold the tower. The support structure further includes legs 102b that help the support structure to stand upright holding the tower. Although, in the example illustrations, three legs are shown, it is possible to have any numbers of legs 102b as long as the support structure holding the tower is able to stand upright in a stable manner.

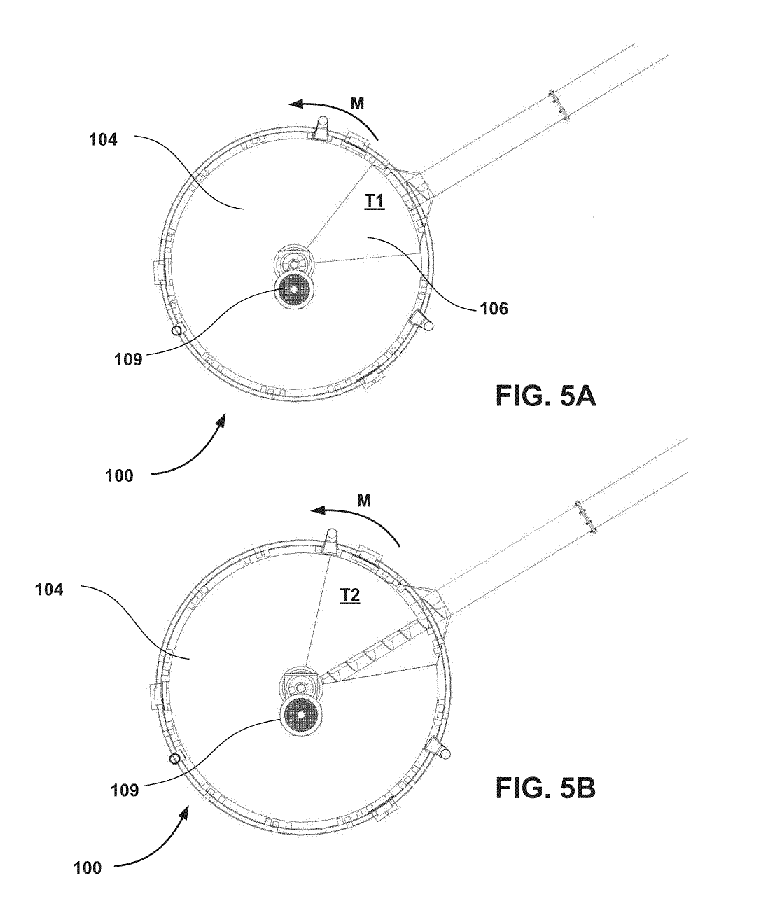

According to the embodiment, the system 100 further includes at least one first passageway, such as passageway 108 with a plurality of nozzles 108a. As shown, the passageway 108 is mountable on the side of the support structure holding the tower for selectively channelling or pumping the organic waste specifically pre-processed or blended form of organic waste, and the one or more species of microorganisms, preferably 5 days old larvae (5 DoL) of Black Soldier Fly (BSF) into selected floors of the first section 104 for them to enable bio-conversion process as shown in the FIG. 4. The nozzles 108a of the passageway 108 are independently controllable using one or more valves (not shown).

According to the embodiment, the system 100 further includes at least one second passageway such as passageway 107a with a plurality of nozzles 107c. The passageway 107a is mountable on the side of the support structure for channelling air into the floors of the first section 104. According to the embodiment, the system 100 further includes at least one third passageway such as a passageway 107b with a plurality of nozzles 107d. The third passageway 107b is mountable on the side of the support structure for channelling air out of the floors of the first section 104. Injecting continuous air into and out of the floors of the first section 104, where the bio conversion process happens facilitates in maintaining adequate moisture level which is required for the larvae of Black Soldier Fly (BSF) to act upon the organic waste. According to the embodiment, the nozzles 107c of the passageway 107a and the nozzles 107d of the passageway 107b are provided with a filter to prevent the microorganisms, i.e BSFL, and the organic waste to enter therein.

According to the embodiment, the system 100 further includes a collection tray 110 adapted for collecting the value added products ejected out of the tower after the treatment/bio-conversion process ends, and a screw conveyor 112 operationally connected to another motor 114. The screw conveyor 112 is configured to receive the value added products from the collection tray 110 and transfer the collected value added products for further processing into a separator (not shown) through an outlet 116.

According to the embodiment, internal walls of the floors 104a of the first section 104 and outer wall of the shaft 106b are coated with hydrophobic coating for ease of cleaning, and harvesting of the value added products from the first section 104 of the tower.

Although, in the forgoing description it is explained that organic waste is channelled or pumped into the floors 104a of the first section 104 of the tower, it should be understood that, the term “organic waste” here refers to pre-processed organic waste, before the resultant organic waste is pumped into the floors 104a of the first section 104 of the tower. The pre-processing essentially includes following steps:
(a) shredding the organic waste into tiny chunks preferably smaller than 5 mm such that BSFLs can efficiently consume or act upon the organic waste.
(b) sorting and transferring the shredded waste to one or more storage tanks based on food types.
(c) adding a chemical agent to the organic waste stored in the storage tanks to maintain safety and freshness of the stored organic waste.
(d) transferring different types of stored organic waste in different ratios from different tanks into a mixer for blending.
(e) adding water and identifying the correct moisture amount for the organic waste during the mixing/blending process. The identification of moisture amount is facilitated by a moisture level sensor. Adequate moisture level at this stage is maintained since BSFLs can treat organic waste that has 80% or above moisture level.
(f) storing, the blended organic waste resulted out of the mixing process/blending process for inputting into the floors 104a of the first section 104 of the tower. For the purpose of this application, the resultant at this step will still be termed as “organic waste”.

In operation, once the blended organic waste (step (f)) or organic waste is ready for distribution to the floors 104a of the first section 104, some pumping system known in the art can deployed to pump/channel the organic waste into the selected floors 104a of the first section 104 via the passageway 108. The nozzles 108a of the passageway 108 are operationally coupled to each of the floors 104a of the first section 104 and individually controllable using valves, so user can selectively pump the organic waste into the selected floors 104a of the first section 104 for bio-conversion process.

Likewise, once the organic waste is pumped into the selected floors 104a of the first section 104, the user can then selectively pump the 5 days old larvae of BSF into the selected floors 104a of the first section 104 using the pumping system via the passageway 108. Although, the embodiments of present invention is describes use of 5 days old BSFLs, it should be understood that within the scope of the scope of present invention, even larvae of 4 days old, 6 days old, 7 days old etc. can also be used, it is just that, 5 days old larvae is capable of yielding better results.

Further to facilitate the bio-conversion process, the user can pump/channel in and out the air to and from the selected floors 104a of the first section 104 using the passageways 107a, 107b in order to maintain adequate level of moisture inside the floors 104a of the first section 104 where bio-conversion takes place.

Next, in the bio-conversion process, the channelled/pumped microorganisms and the organic waste in the first section of the tower are allowed to remain therein for a specific period of time to convert the pre-processed organic waste to value added products such as fertilizers and animal feed. The specific period of time for which the organic waste and BSFLs are allowed to remain under the bio conversion process is preferably but not limited to 14 days (or any time by which the larvae ceases their decomposing capability)

Next, once the bio conversion process ends, the harvesting of the value added products and the microorganism out of the first section 104 takes place. The harvesting is facilitated by rotation of the floors 106b of the second section 106 of the tower within the first section 104. The rotation of the second section 106 within the first section 104, dumps all of the bio converted value added products into the collection tray 110, which is then transferred to a separator for further processing using a screw conveyor 112. The screw conveyor 112 is connected to a motor 114 which rotates the conveyor 112 to transfer the conveyor 112 to the separator using an outlet 116 for separating the larvae out and to obtain the fertilizers and animal feed.

It should be noted that, the organic waste treatment system and associated components thereof described above in the FIGS. 1-5 may be made of any suitable material known in the art, and be made in different sizes that may make the presented invention realization in real scenario.

The preceding description has been presented with reference to various embodiments. Persons skilled in the art and technology to which this application pertains will appreciate that alterations and changes in the described structures and methods of operation can be practiced without meaningfully departing from the principle, spirit and scope of the present invention.

What is claimed is:

1. A system (100) for treatment of organic waste, comprising:
a tower (104,106) including a first section (104), and a second section (106) operationally engaged to the first section (104), each of the first section (104) and the second section (106) comprises a plurality of first floors (104a), a plurality of second floors (106a) respectively, wherein each of the first floors (104a) of the first section (104) is configured to receive and facilitate conversion of the organic waste into one or more value-added products, and serve as a pathway for each of the floors (106a) of the second section (106), when the second section (106) is operated to rotate within the first section (104);
a support structure (102a,102b) configured to support the tower (104,106);
at least one first passageway (108) with a plurality of first nozzles (108a), wherein the first passageway (108) is mountable on the support structure (102a,102b) for selectively channelling at least one of: the organic waste, and the one or more species of microorganisms into selected floors of the plurality of first floors (104a) of the first section (104);
at least one second passageway (107a) with a plurality of second nozzles (107c), wherein the second passageway (107a) is mountable on the support structure (102a,102b) for channelling air into the plurality of first floors (104a) of the first section (104); and
at least one third passageway (107b) with a plurality of third nozzles (107d), wherein the third passageway (107b) is mountable on the support structure (102a,102b) for channelling air out of the plurality of first floors (104a) of the first section (104); and
a first motor (109) adapted for operatively rotating the second section (106) within the first section (104).

2. The system (100) of claim 1, wherein the tower (104,106) is circular or cylindrical in shape.

3. The system (100) of claim 1, wherein the support structure (102a, 102b) comprises:
a plurality of rings (102a) complementing the shape of the tower (104,106), wherein each of the rings (102a) are interconnected to form a disposal space for receiving the tower (104,106); and
a plurality of legs (102b) that help the support structure (102a, 102b) to stand upright.

4. The system (100) of claim 1, wherein the one or more value-added products comprises fertilizers and animal feed.

5. The system (100) of claim 1, wherein the one or more species of microorganisms comprises larvae of Black Soldier Fly Larvae (BSFL).

6. The system (100) of claim 1, wherein the plurality of first nozzles (108a) of the first passageway (108) are independently controllable using a valve corresponding to each of the first nozzles (108a).

7. The system (100) of claim 1, wherein the second section (106) of the tower (104,106) is operationally engaged to the first section (104) using a shaft (106b) configured thereon, wherein the shaft (106b) includes an end that connects to the first motor (109) in order for the first motor (109) to rotate the second section (106).

8. The system (100) of claim 1, wherein the plurality of first floors (104a) of the first section (104) includes a receiving slot (104b) for receiving the shaft (106b) of the second section (106) therein, and to facilitate rotation of the second section (106).

9. The system (100) of claim 1, wherein each of the plurality of second nozzles (107c), and the plurality of second nozzles (107d) of the second passageway (107a) and the third passageway (107b) are provided with a filter to prevent the microorganisms, and the organic waste to enter therein.

10. The system (100) of claim 1, wherein internal walls of the plurality of first floors (104a) of the first section (104) and outer wall of the shaft (106b) are coated with hydrophobic coating for ease of cleaning, and ease of harvesting the value added products.

11. The system (100) of claim 1, wherein each of the plurality of first floors (104a) of the first section (104) are open at two ends in order to facilitate the second section (106) to rotate within the first section (104) to eject the value added products out of the first section (104) after the treatment process ends.

12. The system (100) of claim 1 further comprises
a collection tray (110) adapted for collecting the value added products ejected out of the tower (104,106) after the treatment process ends; and
a screw conveyor (112) operationally connected to a second motor (114), wherein the screw conveyor (112) is configured to receive the value added products from the collection tray (110) and transfer the collected value added products for further processing into a separator through an outlet (116).

13. The system (100) of claim 1, wherein the organic waste are pre-processed before channelling into the selected floors of the plurality of first floors (104a) of the first section (104), the pre-processing includes:
shredding the organic waste into tiny chunks;
sorting and transferring the shredded waste to one or more storage tanks based on food types;
adding a chemical agent to the organic waste stored in the storage tanks to maintain safety and freshness of the stored organic waste;
transferring different types of stored organic waste in different ratios from different tanks into a mixer for blending;
adding water and identifying the correct moisture amount for the organic waste during the mixing/blending process; and
storing, the blended organic waste resulted out of the mixing process/blending process.

14. A method for treatment of organic waste using an organic waste treatment system (100), comprising the steps of:
pre-processing the organic waste to form a blended organic waste;
selectively channelling the pre-processed organic waste into a plurality of first floors (104a) of a first section (104) of a tower (104,106) using at least one first passageway (108) having a plurality of first nozzles (108a);
selectively channelling one or more species of microorganisms into the first floors (104) of the first section (104) of the tower (104,106) using the first passageway (108);
channelling air into and out of the first floors (104) of the first section (104) using at least one second passageway (107a) and at least one second passageway (107b), both having a plurality of first nozzles (107c), and a plurality of first nozzles (107d) respectively;
allowing the channelled microorganisms, and the pre-processed organic waste to remain in the first section (104) of the tower (104,106) for a specific period of time to convert the pre-processed organic waste to one or more value added products; and
harvesting the value added products and the microorganism out of the first section (104), wherein the step of harvesting is facilitated by rotation of a plurality of second floors (106a) of a second section (106) of the tower (104,106) within the first section (104).

15. The method of claim 14, wherein the step of pre-processing comprising steps of:
shredding the organic waste into tiny chunks;
sorting and transferring the shredded waste to one or more storage tanks based on food types;
adding a chemical agent to the organic waste stored in the storage tanks to maintain safety and freshness of the stored organic waste;
transferring different types of stored organic waste in different ratios from different tanks into a mixer for blending;
adding water and identifying the correct moisture amount for the organic waste during the mixing/blending process; and
storing, the blended organic waste resulted out of the mixing process/blending process.

16. The method of claim 14, wherein the one or more value-added products obtained comprises fertilizers and animal feed.

17. The method of claim 14, wherein the one or more species of microorganisms comprises larvae of Black Soldier Fly Larvae (BSFL).

18. The method of claim 17, wherein the larvae of Black Soldier Fly Larvae (BSFL) are 5 days old.

19. The method of claim 14, wherein the rotation of the second section (106) of the tower (104,106) within the first section (104) is facilitated by a motor (109).

20. The method of claim 14, wherein the harvesting of the value added products and the microorganisms is further facilitated by two open ends of each of the first floors (104a) of the first section (104).
